(19) United States
(12) Patent Application Publication
(10) Pub. No.: US 2004/0258504 A1
(43) Pub. Date: Dec. 23, 2004

(54) Heating and cooling system and production system including this heating and cooling system

(76) Inventors: Kazuyoshi Yasukawa, Nagano (JP); Haruhiro Tsuneta, Nagano (JP); Yoshiki Shimura, Nagano (JP); Yoshiharu Mukaiyama, Nagano (JP); Noburo Ueno, Nagano (JP)

Correspondence Address: NOTARO AND MICHALOS, 100 DUTCH HILL ROAD, SUITE 110, ORANGEBURG, NY, 10962-2100, US

(21) Appl. No.: 10/487,703

(22) PCT Filed: Aug. 28, 2002
(86) PCT No.: PCT/JP02/08688

(30) Foreign Application Priority Data
Aug. 28, 2001 (JP) 2001-258589
Jun. 7, 2002 (JP) 2002-167818

(51) Int. Cl. B66C 17/08

(52) U.S. Cl. 414/153

(57) ABSTRACT

A system which performs heating or the like with respect to a workpiece in a production system for a mechanical product such as a motor, and a production system including this system, for decreasing line inventories, continuously maintaining the cleanliness, and decreasing an installation space. The system comprises: a carriage device (41a, 41b) which is arranged in an oven (40) capable of accommodating a plurality of workpieces (2) and carries each workpiece (2) to a supply side or a discharge side in the oven (40); and a control portion which controls the carriage device (41a, 41b). The carriage device (41a, 41b) is operated in accordance with each workpiece (2), and heat treatment statuses of the workpieces (2) are individually managed in the oven (40). The carriage device (41a, 41b) is set in such a manner that an operation drive device (43) as a drive mechanism thereof is positioned outside the oven (40) and only an operation end (41a) which holds the workpiece (2) enters the oven (40).

### TECHNICAL FIELD

The present invention relates to a heating/cooling system and a production system including this heating/cooling system. More particularly, the present invention relates to an improvement in a structure of a heating/cooling system which heats or cools a workpiece in a production system for a mechanical product such as a motor.

### TECHNICAL TERMS

In this specification, a term “oven” means a furnace or a kiln which has a space partitioned by furnace walls and the like and is used to perform a heat treatment or the like for heating a workpiece carried into this space or cooling the same after heating in order to thereafter carry out desired processing (which will be collectively referred to as “heating or the like” hereinafter), e.g., adhesion sealing, or an apparatus having a function corresponding to such a furnace or a kiln.

In this specification, a term “temperature profile” means a conformation to perform heating or cooling in accordance with a function which varies with time instead of setting a temperature constant in case of heating a workpiece or cooling the same after heating.

In this specification, a term “clean process” means a process when performing heating or the like while maintaining a workpiece clean in a clean environment held at a class of, e.g., approximately 100.

In this specification, a term “first in first out” means to sequentially discharge workpieces which are put into the oven first and whose preset time has passed among a plurality of workpieces as targets of heating or the like, namely, it means to discharge workpieces which are precedently inputted.

In this specification, a phrase “flowing workpieces one by one” means to put workpieces into the oven one by one and discharge them one by one.

In this specification, a term “index operation” means an intermittent rotation operation that a circumferential position of a device which rotates, stops and again rotates is calculated and the device is caused to accurately stop at a determined position.

### BACKGROUND ART

Conventionally, as ovens used in a heat process, there are two systems, i.e., a batch-type furnace and a continuous furnace such as shown in FIGS. 44 to 46.

A batch-type furnace 101 (see FIGS. 44 and 45) is of a type that a fixed workpiece processing quantity not more than a numerical quantity which can be mounted in the furnace is determined in advance and the quantity is all switched in accordance with a time of heating and the like, and the oven itself does not have a carriage mechanism in particular. It is to be noted that reference numeral 102 denotes a filter; 103, a heater; 104, a blower; 105, an observation window; 106, a temperature sensor; and 107, a control device in FIG. 45.

On the other hand, a continuous furnace 201 (see FIG. 46) has a carriage device 202 such as a conveyer which pierces the inside of the furnace, carries and puts a workpiece 203 into the furnace, and performs predetermined heating or the like while continuously passing the workpiece. It obtains a desired oven time by adjusting a carriage speed. Reference numeral 204 designates a blower heater filter, and 205 denotes a return path for high-temperature air.

In these systems, a temperature profile can be performed. The batch-type furnace 101 can perform a temperature control over the oven itself, and the continuous furnace 201 can carry out a control by intentionally forming a predetermined three-dimensional temperature distribution in the furnace in accordance with a route of the carriage device 202 such as a conveyor.

In the batch-type furnace 101, however, as a first problem, when a workpiece is heated or the like with a high cleanliness, the cleanliness is maintained by cleaned hot air during heating and the like, but a flow of an air current tends to be generated when opening/closing a door since an opening area of the door is relatively large and a temperature difference between the inside and the outside of the furnace is large, which is disadvantageous in assuring the cleanliness. Further, since a large quantity of workpieces are collectively put in/out in the batch-type furnace 101, the door must be usually largely opened/closed when putting in/out the workpieces, and a lot of the heated air in the furnace flows out to the outside at that moment. Therefore, when again putting in the workpieces and heating them, the energy to again increase the furnace temperature is required, which is a problem in efficiency.

Furthermore, as a second problem, since batch processing is carried out, the number of retained workpieces which are behind in processing is increased during manufacture processes. This is disadvantageous in a line inventory cost or a space, and there is also a problem inherent to the batch processing such as a delay in feedback of failure generation.

Moreover, in case of the continuous furnace 201, as a first problem, there are many processes which require a relatively long time when performing heating and the like with respect to a workpiece 203, and a carriage distance necessarily becomes long, which is disadvantageous in terms of space. As a second problem, since generation of dust from the carriage device 202 such as a conveyor is a problem in case of a clean process in particular, turning up the conveyor in the vertical direction is difficult, and a very large linear space is required. This leads to an increase in heating energy and a deterioration in maintenance, resulting in an expensive apparatus.

It is, therefore, an object of the present invention to provide a heating/cooling system which can reduce line inventories, continuously keep the cleanliness and reduce an installation space, and a production system including this heating/cooling system,

### DISCLOSURE OF INVENTION

To achieve this aim, a heating/cooling system according to the present invention comprises: a carriage device which is arranged in an oven capable of accommodating a plurality of workpieces, and carries each workpiece from a supply opening to a discharge opening in the oven; and a control portion which operates the carriage device in accordance with each workpiece and controls the carriage device so as to manage a heating/cooling status of each workpiece in the oven. According to this heating/cooling system, since the carriage device is operated in accordance with each workpiece and a heating/cooling status of each workpiece is managed in the oven, the problems inherent to batch processing can be solved by flowing workpieces one by one, and the number of retained workpieces can be reduced, thereby decreasing an inventory cost.

Additionally, a heating/cooling system according to the present invention comprises: a robot type carriage device which carries a workpiece; and a control portion which has a function to generate a route of the carriage device as well as functions to manage a heating/cooling time of each workpiece whose number is at least equal to the number of workpieces which can be heated/cooled, and controls the carriage device so as to cause the carriage device to perform a discharge operation when an elapse of a preset time is detected after starting clocking from supply of the workpiece. According to this heating/cooling system, an optimum heating/cooling status can be managed in accordance with each workpiece, and the number of retained workpieces into the oven can be decreased.

Further, a heating/cooling system according to the present invention comprises: a robot type carriage device which carries a workpiece; and a control portion which has a function to generate a route of the carriage device as well as functions to manage a heating/cooling time of each workpiece whose number is at least equal to the number of workpieces which can be heated/cooled, controls the carriage device so as to move a workpiece to another area in a furnace with a different temperature or an installation position when an elapse of a preset time is detected after starting clocking from supply of the workpiece, and starts additionally set clocking. According to this heating/cooling system, a plurality of types of temperature conditions and time conditions are provided in accordance with each workpiece, and an optimum heating/cooling status is managed in accordance with each workpiece, thereby reducing the number of retained workpieces into the oven. Furthermore, different types of workpieces can be put into the oven.

Here, it is preferable that the carriage device of the heating/cooling system is set in such a manner that an operation drive device as a drive device thereof is positioned outside the oven and only an operation end which holds the workpiece enters the oven. In this case, since the heat resistance does not have to be considered in particular in relation to a motor portion, a sliding portion, a lubricating portion and the like of the operation drive device set outside the oven, the carriage device can be reduced in size and inexpensively configured. It is to be noted that workpiece holding includes respective operations such as grasping, sucking or mounting the workpiece.

Moreover, in such a heating/cooling system, it is preferable that the operation end and the operation drive device are connected to each other by a shaft portion and a slit is provided to a furnace wall only in a necessary route of the carriage device. In this case, since the operation end in the oven and the operation drive device outside the oven can be moved along the necessary route constituted of the slit on the furnace wall, the outflow of high-temperature air can be suppressed to the minimum level, and the energy efficiency of a heating portion can be increased while restraining an increase in temperature in a mechanical portion.

Additionally, it is preferable for such a heating/cooling system to have a flange which prevents heated air from flowing out through the slit. In this case, the heated air can be prevented from flowing out, and the energy efficiency can be increased.

Further, it is preferable for the flange in this case to be formed of a first flange provided at a swiveling motor fixing portion connected to a Y shaft movement portion and a second flange provided to the Y shaft fixing portion which moves together with an X shaft. In this case, the heated air can be prevented from flowing out by closing an opening portion by the first flange and the second flange, and it is possible to more effectively avoid diffusion of heat in the oven.

Furthermore, it is preferable for the carriage device in the heating/cooling system to have a structure that a movable portion is not provided on an operation end side away from a shaft portion which connects the operation end with the operation drive device. As a result, generation of dust can be avoided.

Moreover, it is preferable for the heating/cooling system to have a structure that a pivot around which the operation end of the carriage device rotates is hollow and the shaft portion is caused to pierce this pivot. In this case, the pivot and the shaft portion can be balanced when horizontally moving in directions X and Y, and vibrations at the time of carriage can be avoided.

Additionally, it is preferable that the heating/cooling system is configured to have a cover which covers the carriage device, reduce a pressure in a closed space surrounding the movable portion constituted of a cover furnace wall surface, and prevent the dust produced by the carriage device or a gas from entering the oven. In this case, since the pressure of the cover is decreased with respect to the inside of the furnace and outside air, the dust or a gas which may be generated during an operation of the carriage device is prevented from leaking to the outside of the cover and entering the oven.

Further, it is preferable that the heating/cooling system is configured to have a plurality of supply openings or discharge openings for the workpiece and use a necessary opening as a supply/discharge opening in accordance with a process layout before and after the oven and close unused openings with taps. In this case, only the necessary supply/discharge opening can be appropriately used.

Furthermore, it is preferable for such a heating/cooling system to have an emergency discharge opening other than the supply opening or the discharge opening, and include a function to discharge a workpiece to the emergency opening when a mechanical device which performs a subsequent process is yet to receive the workpiece at the discharge opening in the normal state. According to this emergency discharge opening, it is possible to avoid an abnormal state so as to discharge the workpiece to the outside from the oven by an action of hardware when the mechanical device which performs a subsequent process is yet to receive the workpiece at the discharge opening in the normal state.

Moreover, it is preferable for the heating/cooling system to additionally have a maintenance door other than the supply opening or the discharge opening. In this case, a workpiece can be taken out from the oven by opening the maintenance door, or the inside of the oven can be repaired.

Additionally, it is preferable for the heating/cooling system to have a function capable of displaying a position and an elapsed time of a workpiece set in the oven. In this case, a heating/cooling status, a maintenance status and the like of a workpiece can be more accurately grasped.

Further, it is preferable for the heating/cooling system to have a function to stop a workpiece supply operation at the time of abnormality that a workpiece cannot be discharged from the oven. In this case, the abnormal state can be avoided by an action of hardware, e.g., discharging a workpiece by utilizing the emergency discharge opening, and it is also possible to get rid of the abnormal state by controlling software.

Furthermore, it is preferable for the heating/cooling system to have a temperature sensor in the carriage device and thereby include a function capable of measuring a three-dimensional temperature distribution in the oven. In such a case, an optimum workpiece quantity can be obtained based on a measured temperature distribution even if, e.g., the oven is overstuffed with workpieces and a temperature is hence uneven, thereby enabling heating in an appropriate status.

Moreover, it is preferable that the shaft portion of the carriage device in the heating/cooling system is hollow. In this case, air at an arbitrary position in the oven can be collected and a wiring or a tube can be inserted into the shaft portion, for example.

Additionally, the heating/cooling system can have a structure that the carriage device is arranged on the side of the oven and the shaft portion pierces the furnace wall in the horizontal direction. When the shaft portion pierces the furnace wall in the horizontal direction, the operation drive device can be arranged on the side of the oven, and it does not have to be arranged under the oven. Therefore, hot air in the furnace can readily flow in the vertical direction, e.g., from the upper side to the lower side. In this case, a direction in which the hot air for heating should be caused to flow toward a workpiece is determined based on a shape of a workpiece, an attitude of the workpiece when mounted, a structure of a mount base and others, and the hot air in the vertical direction may be better in some cases.

Further, it is preferable for the heating/cooling system to include a cleaning device for a gas which enters the oven. As a result, the gas which enters the oven can be cleaned.

Furthermore, the heating/cooling system can be used in an ultraviolet furnace. It can increase the energy efficiency like the heating oven, and processing with the high cleanliness and less retained workpieces is possible.

Moreover, it is preferable for the heating/cooling system to be set so as to suppress the outflow of heated air in the oven by inserting a workpiece carriage pallet having a workpiece mounted thereon in order to supply the workpiece into the oven or discharge the same from the oven, into an opening portion through which the workpiece is supplied or discharged. When the opening portion of the oven is directly closed by the pallet which has carried a workpiece, heated air can be prevented from flowing out through this opening portion while supplying/discharging the workpiece. Consequently, since heated air can be suppressed from flowing out through the opening portion while supplying or discharging a workpiece to/from the oven or while carrying a workpiece in the oven, waste of a heat capacity can be reduced, and an excessive heating time is not required.

Additionally, a production system including a heating/cooling system according to the present invention comprises: a plurality of mechanical devices each of which has a workpiece operation section in which an operation is performed with respect to a workpiece; a device which maintains the workpiece operation section in a clean atmosphere; a carriage device which moves a workpiece in the workpiece operation section; an operation drive device which drives the carriage device and is provided outside the workpiece operation section; and a carriage path which connects the workpiece operation sections of the respective mechanical devices with each other and through which a workpiece is carried from one mechanical device to another mechanical device, wherein at least one of the mechanical devices is the heating/cooling system according to any of claims 1 to 3. Based on this, it is possible to configure a system which solves problems inherent to batch processing, e.g., a system capable of reducing the number of retained workpieces in a manufacturing process.

### BRIEF DESCRIPTION OF DRAWINGS

FIG. 1 is a plane view showing a production system to which the present invention is applied; FIG. 2 is a plane view showing an example of an internal structure of workpiece operation sections connected through a carriage tube; FIG. 3 is a vertical cross-sectional view showing an example of the internal structure of the work operation sections connected by the carriage tube; FIG. 4 is a plane view showing side walls of work areas and the carriage tube with a cover; FIG. 5 is a plane view showing a structure of the carriage tube from which the cover is removed; FIG. 6 is a plane view of the carriage tube, showing only a linear motor with a workpiece mount base being removed; FIG. 7A is a plane view showing a structure of the carriage tube with a cover; FIG. 7B is a front view showing the structure of the carriage tube with a cover; FIG. 7C is a right-hand side view showing the structure of the carriage tube with a cover; FIG. 8 is a front view showing a carriage duct provided so as to cut across three mechanical devices; FIG. 9 is a plane view showing another mode of the production system; FIG. 10 is a view showing a structural example of a cleansing system including a clean descending air current generation device; FIG. 11A is a horizontal cross-sectional view showing an internal structure of the cleansing system; FIG. 11B is a vertical cross-sectional view showing the internal structure of the cleansing system; FIG. 12 is a partial cross-sectional view showing an insertion hole of a workpiece processing portion and a step-shaped carriage arm having a workpiece inserted therein from the insertion hole; FIG. 13 is a partial cross-sectional view showing a shape example of a partition wall to which a carriage path is formed; FIG. 14 is a partial cross-sectional view of a cleansing system including a flowing water jet device; FIG. 15 is a partial cross-sectional view of the cleansing system designed to change a direction of the flowing water jet device by using a jet angle change mechanism using a linear motor; FIG. 16 is a partial cross-sectional view of a cleansing system including a vertical movement mechanism such as a linear motor which moves up and down workpiece cleansing means and a rotation mechanism such as a rotary motor; FIG. 17 is a partial cross-sectional view of a cleansing system having a clean hot air jet mechanism provided to a workpiece processing portion; FIG. 18 is a partial cross-sectional view of a cleansing system in which a device to change a workpiece holding position of a carriage arm is set; FIG. 19 is a perspective view of a cleansing system having a structure that the workpiece processing portions can be individually removed; FIG. 20 is a plane view of a carriage arm of a carriage device which finely vibrates or quivers a workpiece; FIG. 21 is a horizontal cross-sectional view showing from the above an internal structure of a heating/cooling system to which the present invention is applied; FIG. 22 is a cross-sectional view showing from a front the internal structure of the heating/cooling system to which the present invention is applied; FIG. 23 is a cross-sectional view showing from a side the internal structure of the heating/cooling system to which the present invention is applied; FIG. 24 is a perspective view showing the internal structure of the heating/cooling system to which the present invention is applied; FIG. 25 is a perspective view showing a primary structural example of a carriage device; FIG. 26 is a perspective view showing a second flange attached to the carriage device; FIG. 27 is a perspective view showing first and second flanges attached to the carriage device; FIG. 28 is a plane view showing the first and second flanges attached to the carriage device; FIG. 29 is a vertical cross-sectional view showing a structural example of the carriage device and a pivot; FIG. 30 is a partial cross-sectional view of the heating/cooling system showing a state that a workpiece is discharged from an emergency discharge opening; FIG. 31 is a partial cross-sectional view of the heating/cooling system showing a discharge state following FIG. 30; FIG. 32 is a partial cross-sectional view of the heating/cooling system showing a discharge state following FIG. 31; FIG. 33 is a partial cross-sectional view of the heating/cooling system showing a discharge state following FIG. 32; FIG. 34 is a view showing an example of a workpiece management database used to manage data for each workpiece; FIG. 35 is a flowchart showing an outline of a system control when a time to perform heating and the like with respect to a workpiece is managed; FIG. 36 is a perspective view of another embodiment of the present invention, showing an example of a mechanism to drive a Z shaft; FIG. 37 is a perspective view showing a structure of an oven and its periphery in another embodiment according to the present invention; FIG. 38 is a plane view showing a positional relationship between an opening portion of the oven and the second flange in a workpiece supply standby mode; FIG. 39 is a plane view showing a positional relationship between the opening portion of the oven and the second flange in the workpiece supply standby mode; FIG. 40 is a plane view showing a positional relationship between the opening portion of the oven and the second flange after supplying a workpiece; FIG. 41 is a schematic view showing a mode that a workpiece carriage pallet larger than the opening portion is put on and covers the opening portion; FIG. 42 is a schematic view showing a mode that an edge portion of the workpiece carriage pallet is pressed against and covers a step portion provided at a rim of the opening portion; FIG. 43 is a perspective view showing the oven and the like when used as a cooling furnace; FIG. 44 is a perspective view of a batch type furnace which is one of conventional heating/cooling systems; FIG. 45 is a cross-sectional view showing from a side surface the batch type furnace which is one of the conventional heating/cooling systems; and FIG. 46 is a schematic cross-sectional view showing from a side a continuous furnace which is one of the conventional heating/cooling systems.

### BEST MODE FOR CARRYING OUT THE INVENTION

A structure of the present invention will now be described in detail hereinafter based on best embodiments shown in the accompanying drawings.

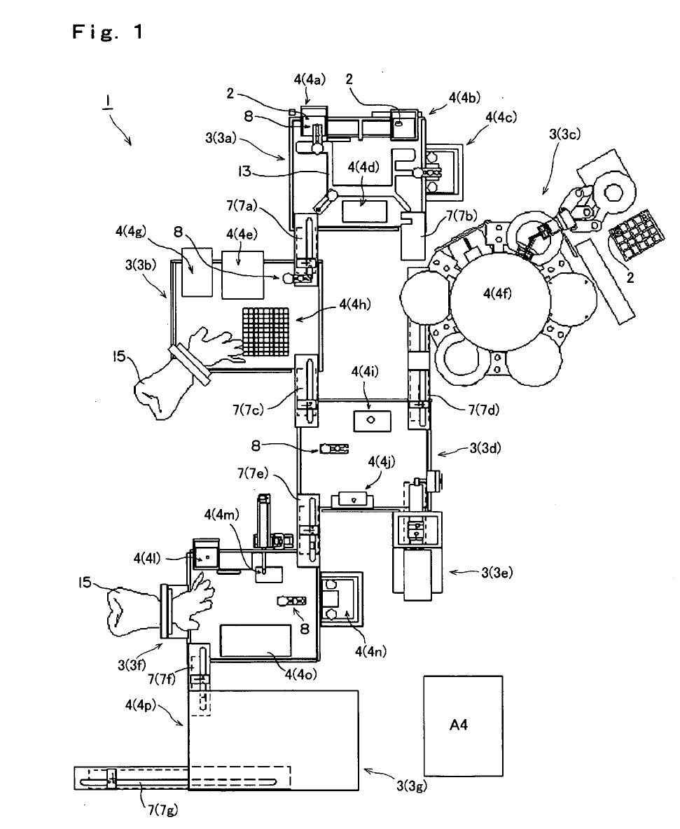

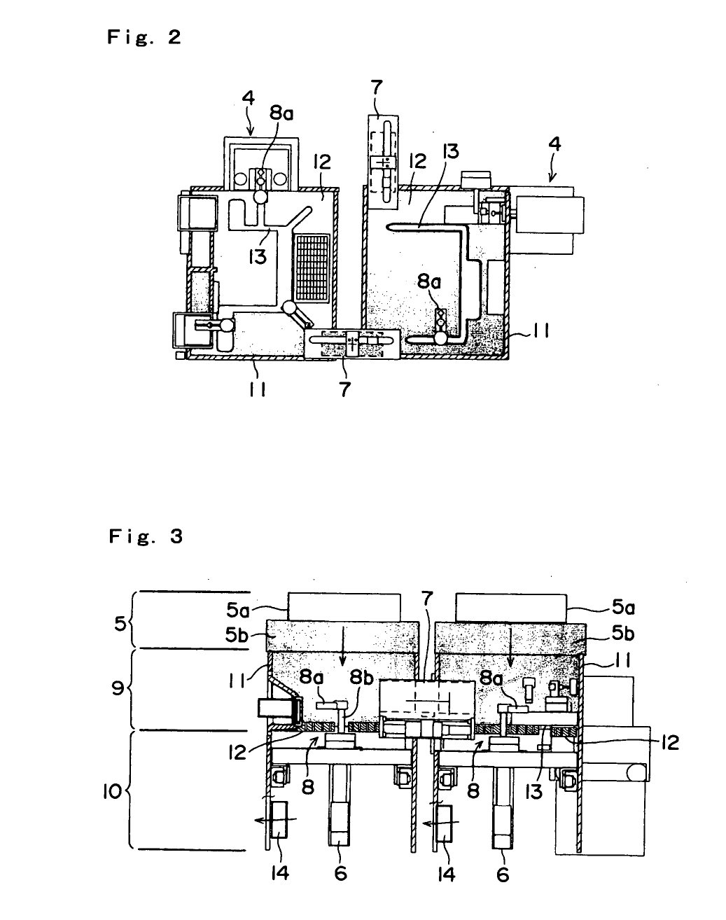

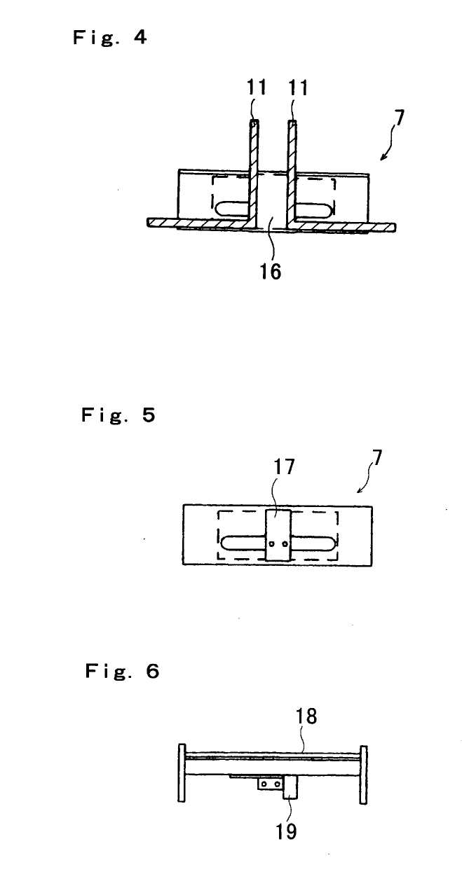

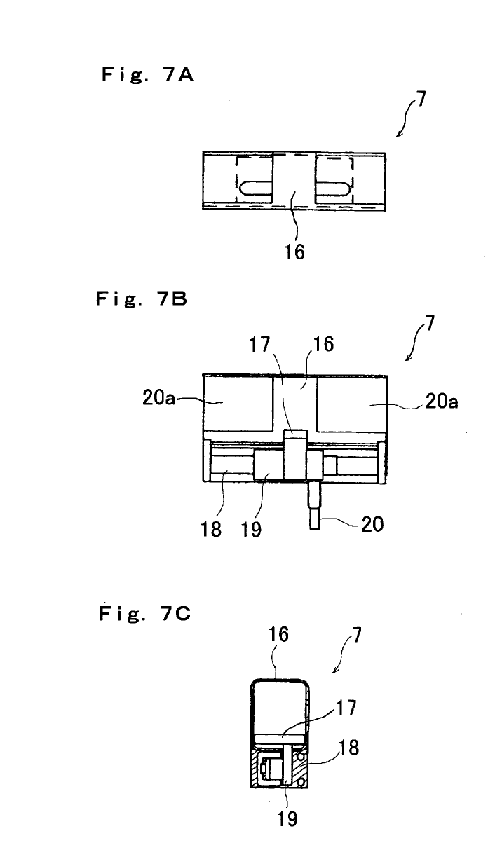

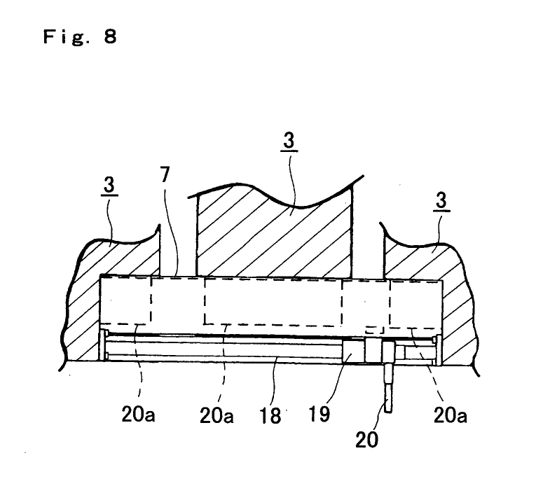

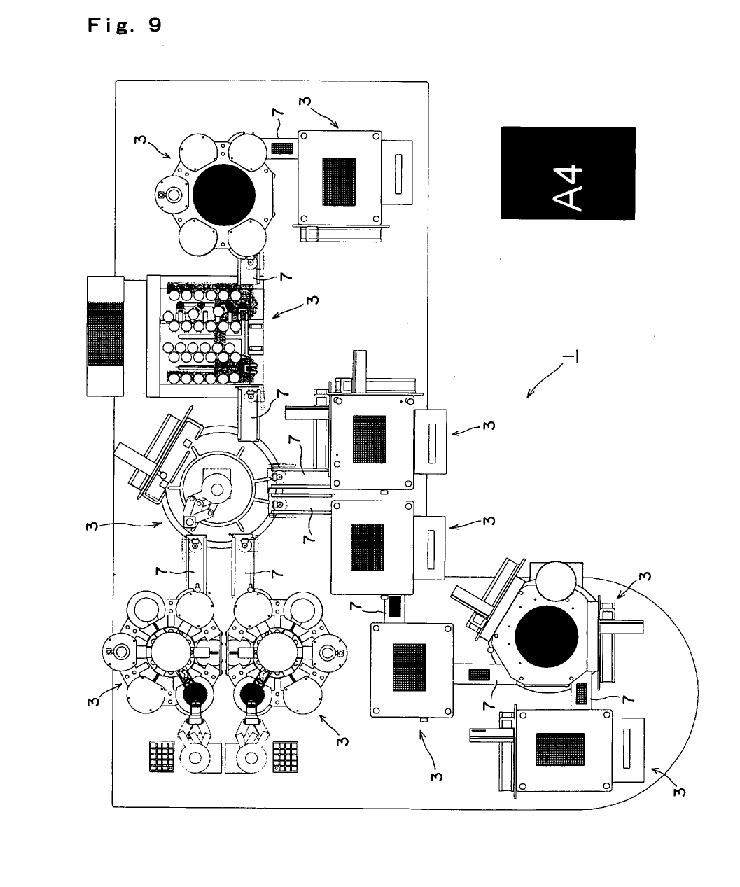

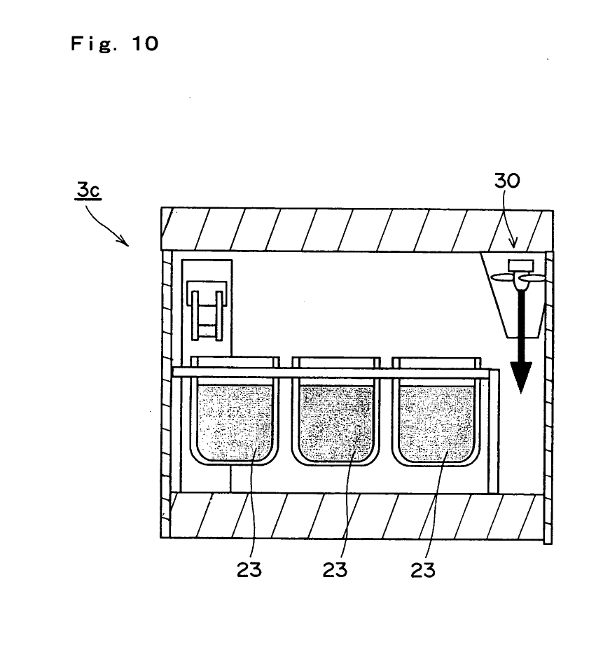

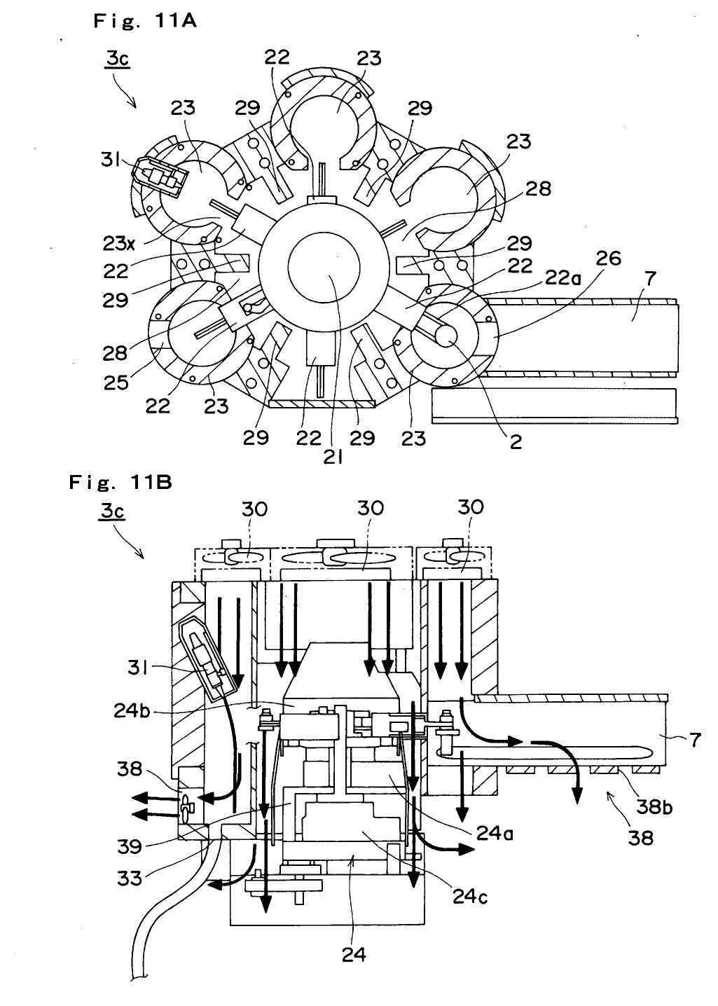

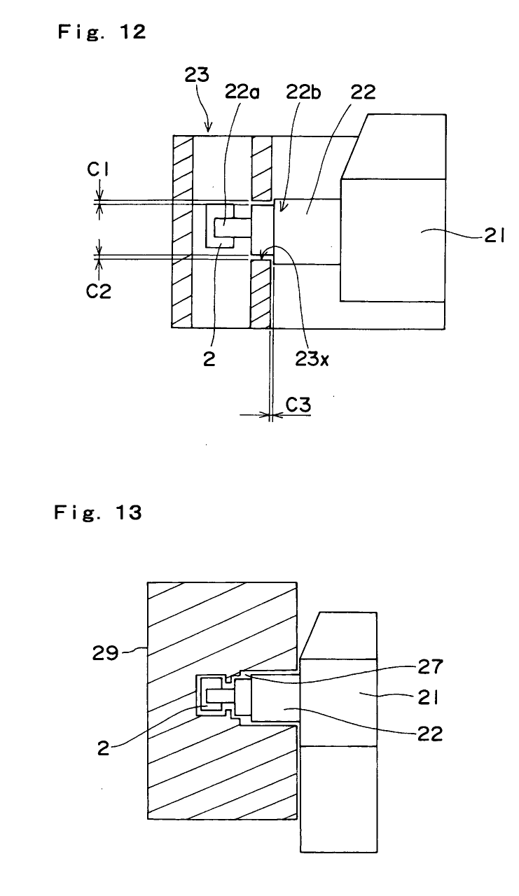

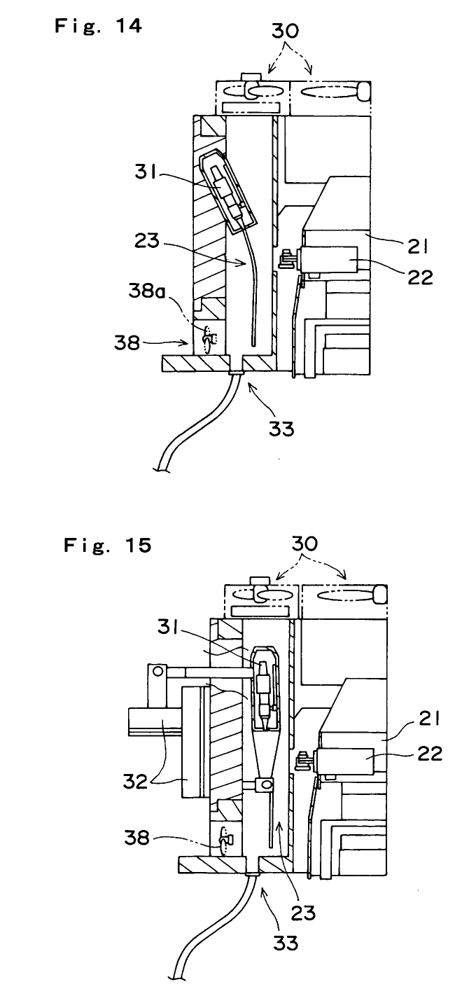

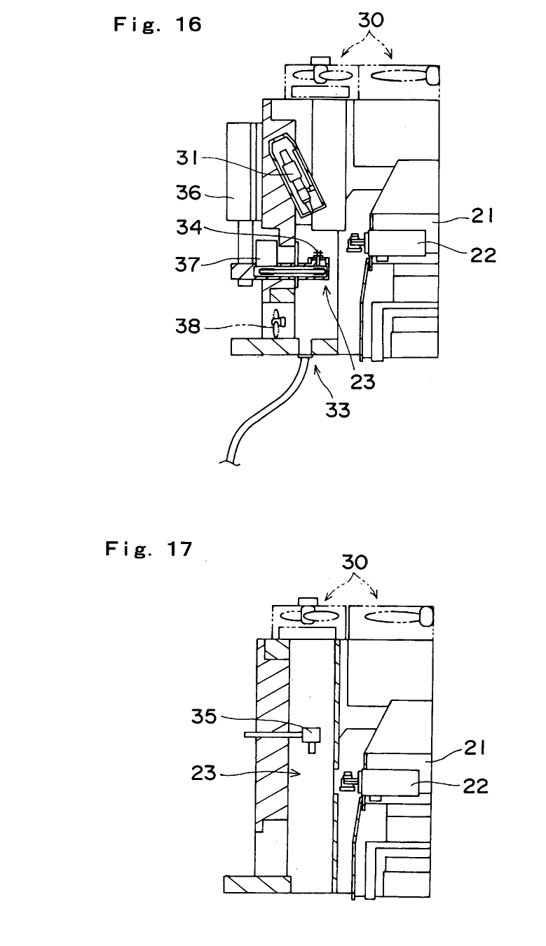

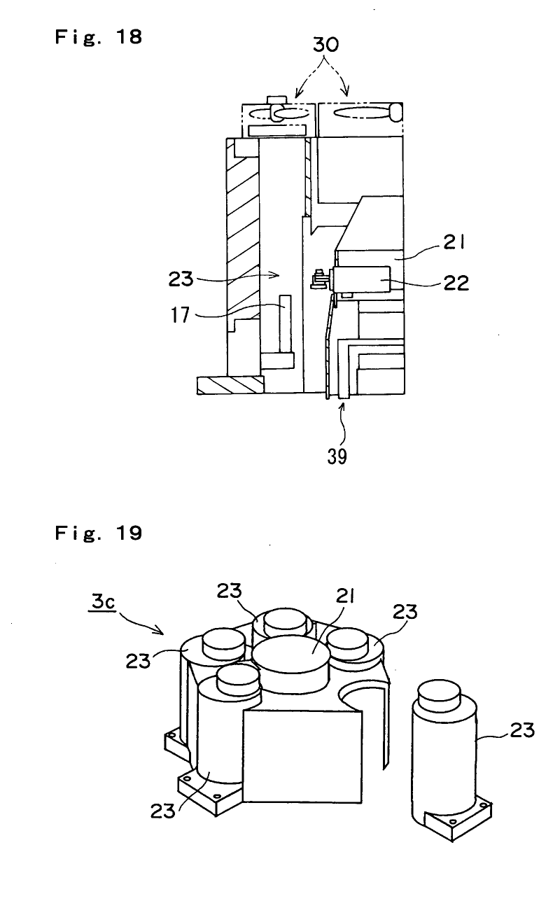

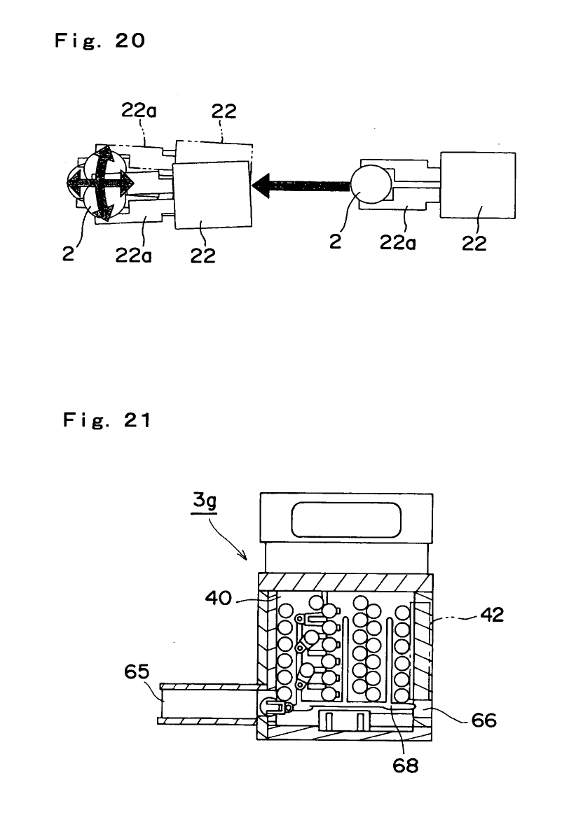

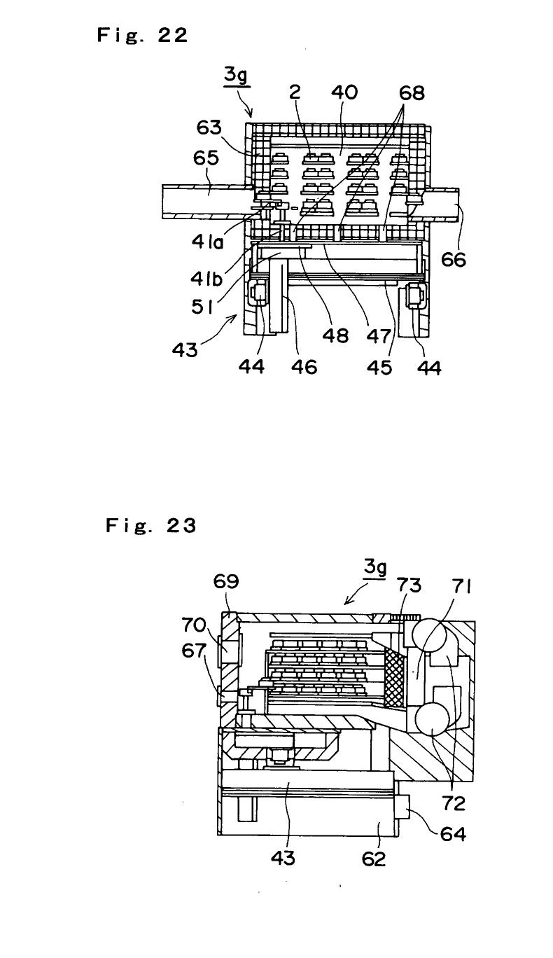

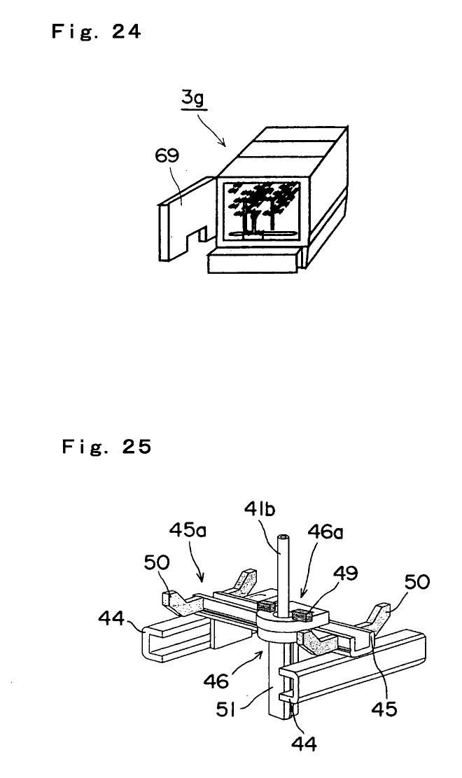

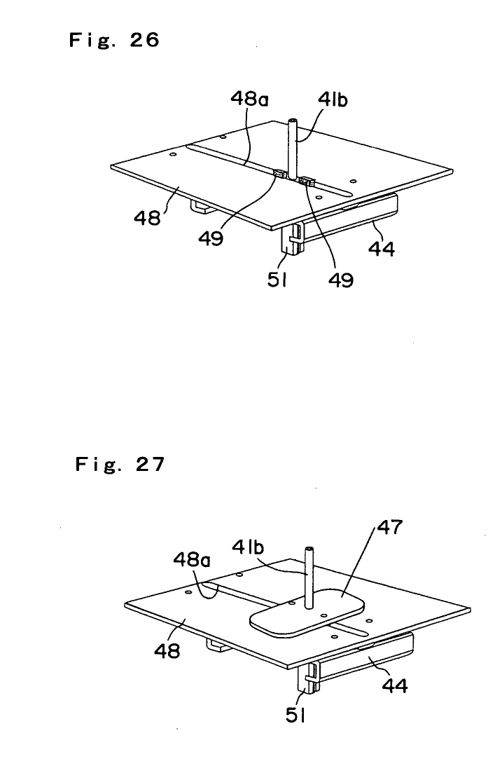

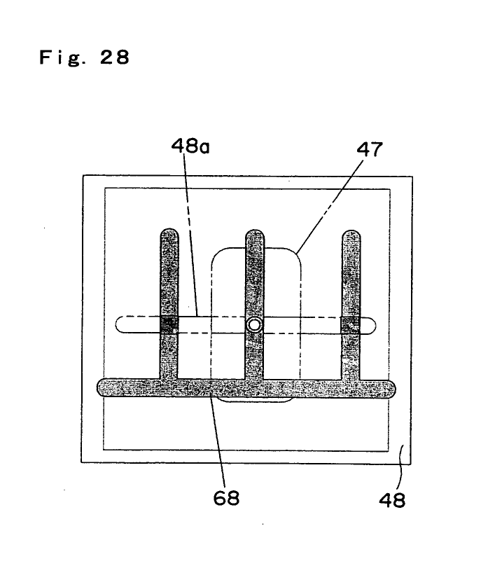

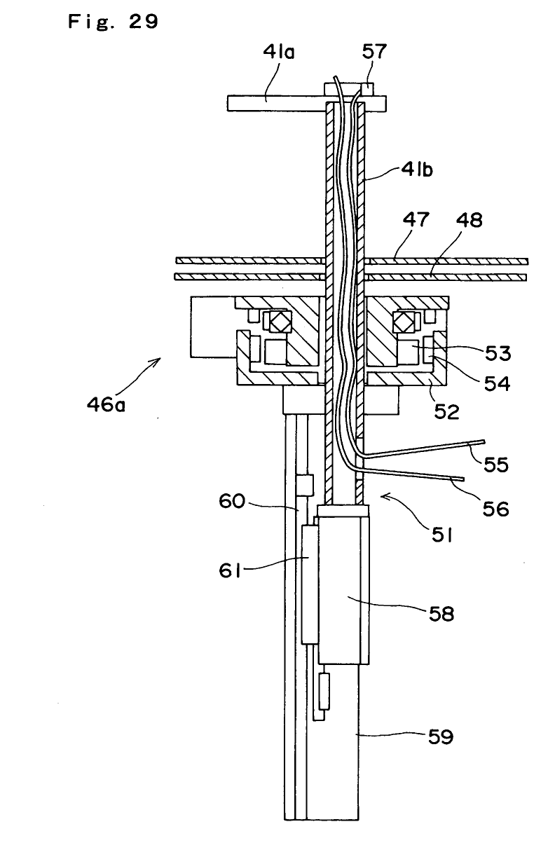

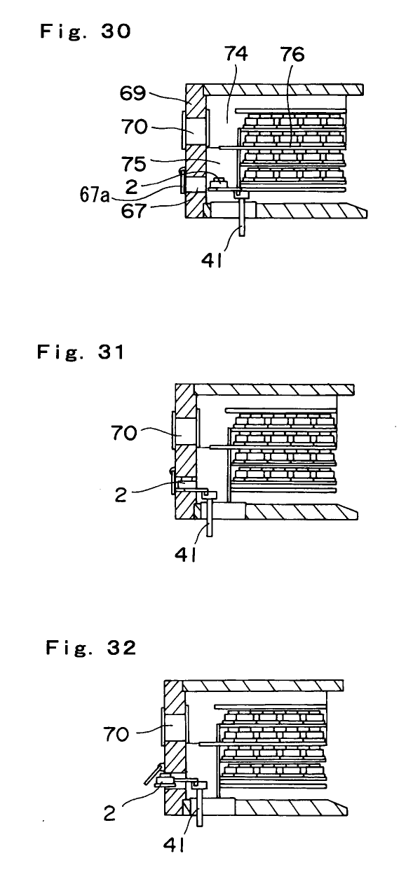

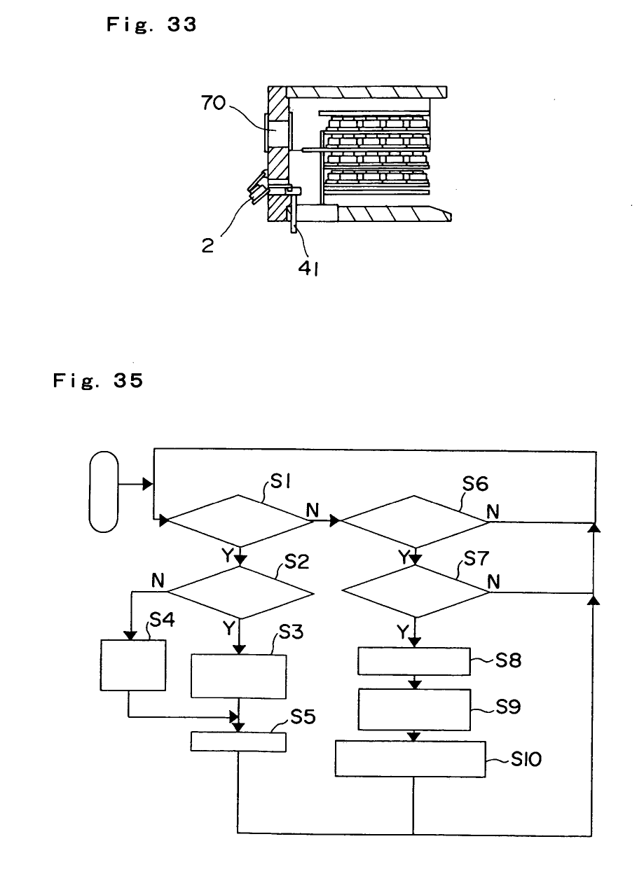

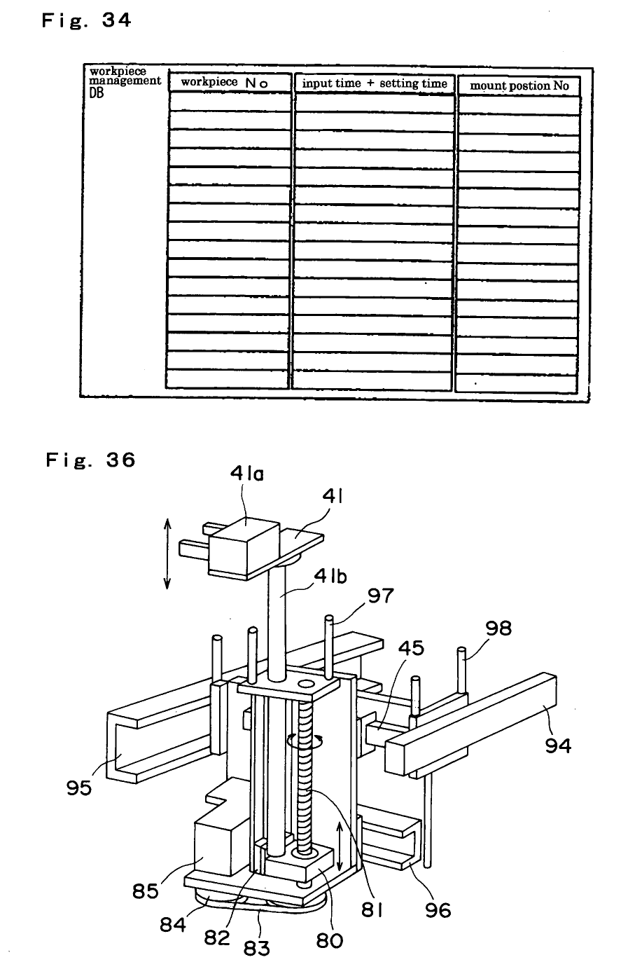

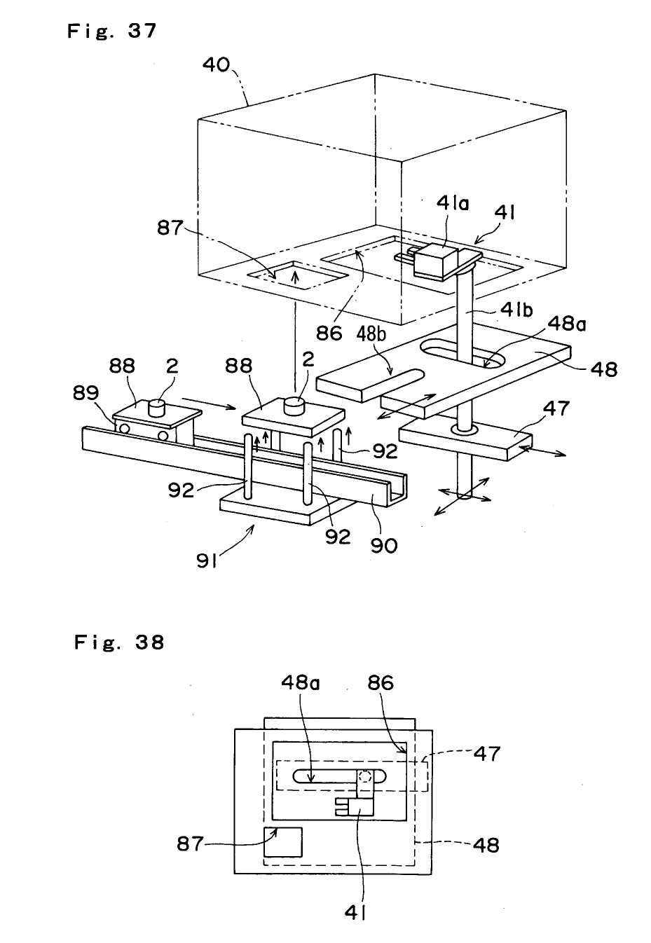

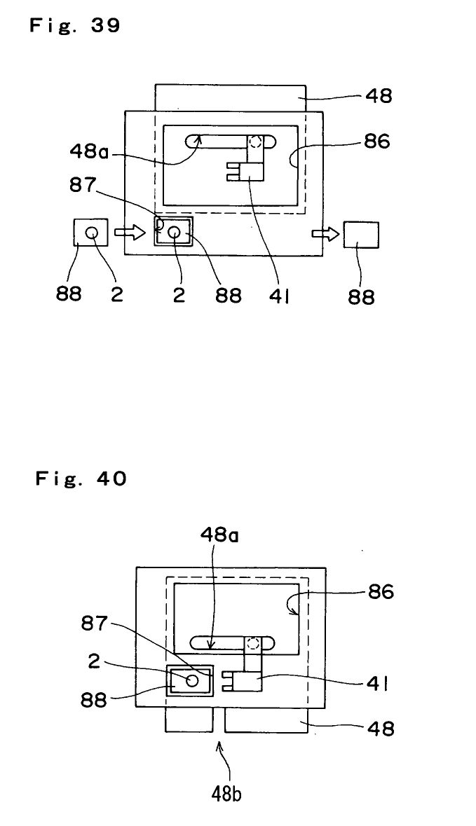

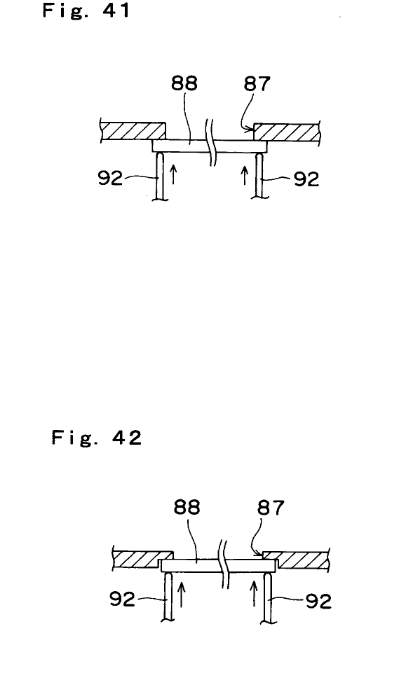

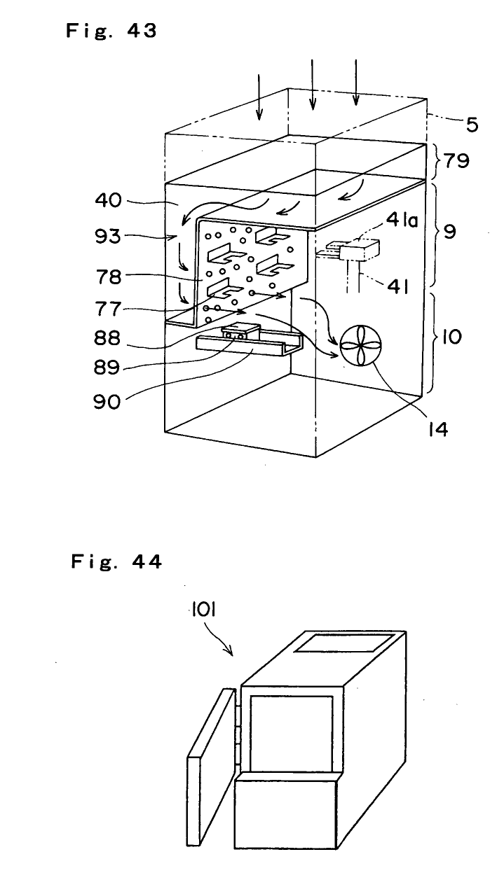

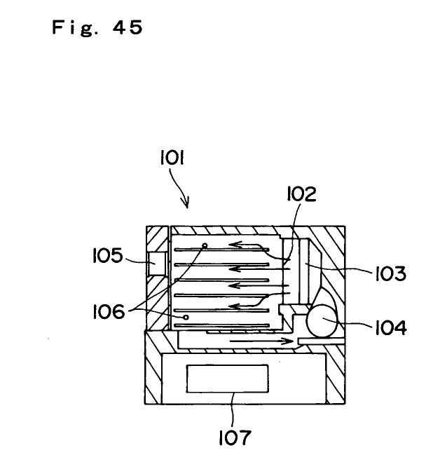

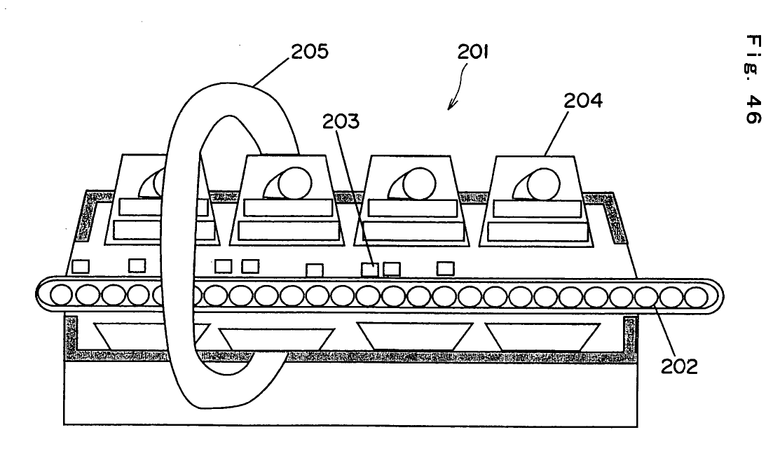

FIGS. 1 to 8 show a production system 1 to which a heating/cooling system according to the present invention is applied. The production system 1 comprises: a plurality of mechanical devices 3 each having a workpiece operation section 4 in which operations such as processing, assembling, heating, cleansing and others are performed to a workpiece 2; a device 5 which maintains the workpiece operation section 4 in a clean atmosphere of a class of approximately 100 (which will be referred to as a “cleaning device 5” hereinafter); a carriage device 8 which moves a workpiece 2 in the workpiece operation section 4; an operation drive device 6 which drives the carriage device 8 and is provided outside the workpiece operation section 4; and a carriage path 7 which connects the workpiece operation sections 4 of the respective mechanical devices 3 with each other, and carries the workpiece 2 from one mechanical device 3 to another mechanical device 3. It is to be noted that FIG. 1 also shows a A4-size paper sheet (size: 297 mm×210 mm) as a comparison target in order to illustrate a schematic size of the production system 1 in this embodiment.

An embodiment of the production system 1 which produces a dynamic bearing motor will be described hereinafter. The production system 1 according to this embodiment includes a plurality of mechanical devices 3 denoted by reference characters 3a to 3g in parentheses as shown in FIG. 1. These mechanical devices 3a to 3g are partitioned into three areas, i.e., a clean descending air current generation area constituted of a cleaning device 5, an operation area 9 and a mechanism area 10 as shown in FIG. 3 and connected to each other by a plurality of carriage paths 7 (denoted by reference characters 7a to 7g in parentheses in FIG. 1) in a state cut off from outside air. A dynamic bearing motor as an example of the workpiece 2 or components constituting this motor are carried between the respective mechanical devices 3a to 3g appropriately through the carriage paths 7a to 7g.

The respective mechanical devices 3a to 3g have a single or a plurality of workpiece operation sections 4 such as a motor bearing supply section 4a which are respectively independent, held in the clean atmosphere and have different functions, in order words, respective operation departments in which the dynamic bearing motor as the workpiece 2 is processed/assembled in the assembly line production manner. It is to be noted that the respective workpiece operation sections 4 are different sections denoted by reference characters 4a to 4p in parentheses in FIG. 1. For example, in this embodiment, the mechanical device 3a has a motor bearing supply section 4a, a plate supply section 4b, a shaft press fitting section 4c and a heater section 4d; the mechanical device 3b has a verticality inspection section 4e; the mechanical device 3c has a cylinder cleansing section 4f; the mechanical device 3e has a cylinder inside diameter measuring section 4k; the mechanical device 3f has a bottom adhesion sealing section 4m, a bottom shrink fitting section 4n and a heat section 4o; and the mechanical device 3g has a heating/cooling section 4p. Further, a shaft diameter measuring section 4g, a stock section for each framework/shaft diameter 4h, a corresponding framework selection section 4i and a shaft insertion section 4j are provided in a space extending from the mechanical device 3a to the mechanical device 3d. In this case, although the respective workpiece operation sections 4 are basically arranged in the lengthwise direction along which the workpiece 2 is fed, additional operation areas may be provided in the lateral direction according to needs. The mechanical device 3c forms a cleansing system as will be described later.

The cleaning device 5 supplies clean air into the operation area 9 in the clean descending air current generation area and maintains the inside the workpiece operation section 4 in the clean state. For example, in case of the production system 1 according to this embodiment, the cleaning device 5 is constituted of a blower 5a which blows out air and a filter 5b which cleans the blown air as shown in FIG. 3, and the operation area 9 is managed to be constantly in a positive pressure state (i.e., a state with a positive pressure) with respect to the outside of the operation area 9 or the mechanism area 10 by supplying a descending flow of the clean air into the operation area 9. Furthermore, in order to generate an appropriate clean processing air current, non-illustrated controlling means used to variably adjust a discharge pressure or a discharge quantity of the blower 5a is also provided.

The operation area 9 is an operation space which has four side walls 11 and has the cleaning device 5 attached at the upper part thereof, and processing/assembling of the dynamic bearing motor is carried out in this space in which the clean atmosphere is maintained. The operation area 9 can be reduced in size within a limit required to perform processing/assembling of the workpiece 2.

On the other hand, the mechanism area 10 has exhaust means 14 and is controlled so as to have a negative pressure as compared with the operation area 9 and a positive pressure as compared with outside air. When the positive pressure not less than that of the outside air is obtained, stopping the exhaust means 14 in that period can thereby decrease a power consumption, which is preferable. The mechanism area 10 has a door provided to at least one surface of the four side walls 11. Moreover, although not shown in particular, at a position with a high possibility of generation of the dust in the upper part of the mechanical area 10, a negative pressure source is guided and sucked by a tube.

A partition wall 12 between the operation area 9 and the mechanism area 10 is movably provided at a part where the operation area 9 has a positive pressure as compared with the mechanism area 10 in order to prevent air from entering the operation area 9 side from the mechanism area 10 side. Additionally, a wall such a grating or a punching metal is provided at any other part so that the operation area 9 and the mechanism area 10 are partitioned from each other. Holes are formed to such partition walls 12, and the operation drive device 6, the carriage path 7 or the carriage device 8 can be directly or indirectly attached to these holes. Further, by providing a glove 15 which enables the operation while shutting off outside air to the partition wall 12 or the holes on the side walls 11, it is possible to include a function which enables a maintenance/security operation, e.g., manually moving the workpiece 2. Furthermore, a slit 13 is cut on the partition wall 12 along a movement route of a shaft portion 8b of the carriage device 8.

The carriage device 8 is constituted of a device such as a robot which is set so as to perform movement/carriage of the workpiece 2 from the outside of the workpiece operation section 4, it is set in such a manner that at least an operation end 8a such as a tool or a hand can enter the operation area 9, and it has a structure that the operation end 8a is connected with the operation drive device 6 as a drive source of the carriage device 8 by the shaft portion 8b. This carriage device 8 approaches the workpiece 2 from the outside of the workpiece operation section 4 and, e.g., holds the workpiece 2 in the workpiece operation section 4 or moves the same between the workpiece operation section 4 and the carriage path 7. As the operation end 8a, it is possible to adopt a device which holds the workpiece 2 as well as any device which has a function of, e.g., hanging or thrusting and can move the workpiece 2.

FIGS. 4 to 8 show an example of the carriage path 7. The carriage path 7 according to this embodiment is a tube with a cover 16 which has an end inserted into a part between the operation area 9 and the mechanism area 10 and connects the mechanical device 3 on the upstream side with the mechanical device 3 on the downstream side (which will be referred to as a “carriage tube 7” hereinafter), and a workpiece mount base 17 is provided on the inner side of the cover 16 as shown in FIG. 5 illustrating a state that the cover 16 is removed. Moreover, a stator 18 and a mover 19 of a linear motor are provided on the lower side of the workpiece mount base 17 as shown in FIG. 6. The mover 19 supports the workpiece mount base 17 as shown in FIGS. 7A to 7C, and linearly moves along the stator 18. Reference numeral 20 denotes a wire which, e.g., supplies a power to the linear motor. Additionally, a part of the carriage tube 7 without the cover 16 is a window 20a opened to the inside of the mechanical device 3, and the carriage device 8 can take out the workpiece 2 through this window 20a. Further, FIG. 8 shows the carriage tube 7 which is provided so as to pierce the middle mechanical device 3 and cut across the three mechanical devices 3. A plurality of windows 20a are provided to this carriage tube 7 in accordance with the respective mechanical devices 3. It is to be noted that the inside of each mechanical device 3 is shown by hatching only in FIG. 8. It is most preferable that the inside of the carriage tube 7 is maintained in the clean atmosphere and the carriage tube 7 can carry the workpiece 2 which is in a manufacturing process from the upstream side mechanical device 3 to the downstream side mechanical device 3 while maintaining the cleanliness. In this case, an air-tight tube which can isolate the operation area 9 from outside air is preferable as the carriage tube 7. However, even if the perfect air-tightness is not realized due to provision of, e.g., a slit, air can be vented through this slit by keeping a positive pressure in the operation area 9, thereby preventing the dust from entering. Furthermore, it is preferable if a joint of the carriage tube 7 is normalized/standardized since such a joint facilitates attachment/detachment. In the production system 1 according to this embodiment, a supply/discharge mechanism used to supply and discharge the workpiece 2 with respect to each workpiece operation section 4 is constituted of the carriage tube 7 and the carriage device 8 mentioned above.

In case of manufacturing the dynamic bearing motor by the above-described production system 1, each unit constituting the dynamic bearing motor, e.g., a motor shaft or a plate is first supplied from a supply opening provided on the side wall 11 of the workpiece operation section 4. Cylinder cleansing of a cylindrical workpiece 2 which will be a motor case is performed by using ultrasonic flowing water obtained by superposing ultrasonic waves on, e.g., cleansing flowing water or scrub cleansing using a brush while appropriately changing a jet direction. It is to be noted that a workpiece processing portion 23 itself can be replaced in the cylinder cleansing section 4f, and the number of the workpiece processing portions 23 can be freely set. Moreover, a motor shaft diameter is measured after the shaft press fitting, and the shafts are classified and stocked in accordance with each diameter. Then, an inside diameter of each cylinder is measured, a shaft having an inside diameter which matches with the former diameter is selected, and this shaft is inserted into the cylinder. Additionally, a plate is caulked, an adhesive is applied to the plate in order to avoid leakage of an oil, and the adhesive is molten by heating after assembling, thereby achieving adhesion sealing. In this case, a plurality of workpieces (motor components) can be heated at a time by carrying out heating in an oven 40 like this embodiment. Further, at least one workpiece must be always set in the oven 40, a time is informed by a timer, and a next workpiece 2 is set at the end of a line for the oven 40 when the heated workpiece 2 is carried from the oven 40, thereby improving the efficiency.

A cleansing system in the production system 1 will now be described (see FIGS. 11A to 20). The cleansing system in the production system 1 according to this embodiment is a system formed of the mechanical device 3c used to cleans the workpiece 2, and constitutes the cylinder cleansing section 4f. This mechanical device 3c will be referred to as a “cleansing system 3c” hereinafter.

The cleansing system 3c has a carriage device 21 which carries the workpiece 2 to a predetermined position, a plurality of workpiece processing portions 23 arranged in a radial pattern around the carriage device 21, a drive portion 24 which drives the carriage device 21, a workpiece supply portion 25 which supplies the workpiece 2, and a workpiece discharge portion 26 which discharges the workpiece 2. The number of carriage arms 22 which carry the workpiece 2 while maintaining a workpiece 2 holding attitude constant in cleansing by, e.g., grasping and mounting or sucking the workpiece 2 and increasing a cleansing area as large as possible when holding the workpiece 2, is larger than the number of the workpiece processing portions 23. In this embodiment, the carriage arm 22 which grasps one workpiece 2 from both sides by using a carriage hand 22a is illustrated as an example. It is to be noted that a plurality of carriage hands 22a which grasp one workpiece 2 may be provided to the carriage arm 22.

The workpiece processing portion 23 is a cleansing tank or a drying tank for the workpiece 2. It is preferable that the workpiece processing portions 23 are arranged in the circumferential direction around the carriage device 21 at equal intervals. In this case, the drive portion 24 can perform a forward feeding operation at an equal angle according to an arrangement angle of the workpiece processing portion 23.

Further, at least one of the workpiece processing portions 23 has a structure that the workpiece 2 can be supplied from the outside of the cleansing system 3c, and at least another workpiece processing portion 23 has a structure that the cleansed workpiece 2 can be discharged to the outside of the cleansing system 3c. For example, in this embodiment, as shown in FIG. 11A, a hole through which the workpiece 2 can be carried in is provided as a workpiece supply portion 25 to the workpiece processing portion 23 which performs first cleansing, and a hole through which the cleansed workpiece 2 can be carried out is provided as a workpiece discharge portion 26 to the workpiece processing portion 23 which conducts last cleansing. Furthermore, each workpiece processing portion 23 has an insertion hole 23x through which the workpiece 2 held by the carriage device 21 is supplied/discharged, and a device which changes a grasping position of the carriage arm 22 with respect to the workpiece 2 is set as shown in FIG. 18. For example, the workpiece grasping position can be changed by temporarily putting the held workpiece 2 on the workpiece mount base 17, moving the carriage arm 22 by a vertical movement mechanism 39 and then again grasping the workpiece 2, and these devices constitute the device which changes the grasping position. An attachment hole for a component used for cleansing, e.g., a cleansing brush is provided on the side surface of the workpiece processing portion 23. The mechanism 39 which moves up and down the carriage arm 22 can be constituted by a combination of, e.g., an actuator or a cam of a motor.

Moreover, it is preferable that the workpiece processing portion 23 has a structure that an upper component such as a lid component can be removed in the upper direction or the lateral direction and its inner wall can be manually cleaned. The workpiece processing portions 23 according to this embodiment can be individually removed as shown in FIG. 19, and the inner wall of each workpiece processing portion 23 can be manually cleaned when removed.

Additionally, it is preferable for the cleansing system 3c that a clean descending air current flows through the entire system and a descending air current which linearly flows down to the lower portion of the cleansing system 3c is formed in the vicinity of the workpiece discharge portion 26. In this embodiment, as shown in FIGS. 10 and 11B, a clean descending air current generation device 30 made up of a fan, a filter and others at an end in the cleansing system 3c is provided so as to generate a descending air current in the cleansing system 3c. Further, the cleansing system 3c of this embodiment has a carriage portion 28 and a carriage path 27 by which the cleansed workpiece 2 is carried, and a linear air current path is assured to the lowermost portion of the system in such a manner that the descending air current in the carriage portion 28 can linearly flow down. Therefore, when the workpiece 2 (and the carriage arm 22) moves, contaminations in the workpiece processing portion 23 on a precedent stage can be prevented from being brought into the next workpiece processing portion 23.

The drive portion 24 is a member which drives the carriage device 21, and the drive portion 24 according to this embodiment has, e.g., an index actuator 24a which operates the carriage device 21 to rotate, a rotation portion 24b which performs an index operation, and an arm expanding actuator 24c which operates the carriage arm 22 to expand/contract as shown in FIGS. 11A and 11B. Here, it is preferable for the drive portion 24 to enable an operation at a sufficiently small angle taking into consideration a size of the workpiece 2 because a fine positional adjustment can be thereby enabled.

The carriage device 21 can insert the workpiece. 2 into the workpiece processing portion 23 in the horizontal direction by expanding/contracting the carriage arm 22 (see FIG. 11A), and can move up and down the workpiece 2 by using the mechanism 39 which moves up and down the carriage arm 22. In this case, since each or all of the carriage arms 22 can slightly expand/contract at the same time, the workpiece 2 held by the carriage arm 22 in a movable range can be horizontally moved to any position, and it can be also moved up and down at each position.

In this embodiment, the workpiece 2 is carried in from the workpiece supply portion 25 by using the carriage device 21 mentioned above, it is moved to a desired workpiece processing portion 23, and it is carried out of the workpiece discharge portion 26. However, such operations may be relatively performed. That is, if a mechanism by which all the workpiece processing portions 23 can be horizontally moved in a radial pattern is provided, the workpiece 2 can be relatively moved to the workpiece processing portion 23 side without being horizontally moved, and the carriage arms 22 do not have to be moved up and down by providing a mechanism which moves up and down the workpiece processing portion 23.

The carriage arm 22 has a step-shaped base portion 22b as shown in FIG. 12. The base portion 22b having such a shape can narrow clearances of the insertion hole 23x of the workpiece processing portion 23 and prevent a cleansing liquid from splashing on the carriage device 21 side. For example, in this embodiment, radial clearances C1 and C2, and an axial clearance C3 between the carriage arm 22 and the insertion hole 23x are as shown in FIG. 12, and the cleansing liquid can be prevented from splashing by narrowing these values so as not to obstruct the movement of the carriage arm 22.

Additionally, if the carriage arm 22 can be cleansed together with the workpiece 2, the cleanliness of a part of the carriage arm 22 in the vicinity of the workpiece can be assured, which is preferable. In this case, although not shown in detail in particular, at least one tank may be provided in a space extending from the workpiece supply portion 25 to the workpiece discharge portion 26 and this tank may be used to cleanse the carriage arm 22.

Partition walls 29 which partition the workpiece processing portions 23 into units are provided to the carriage portion 28 to which the workpiece 2 is actually carried between the workpiece processing portion 23 and the carriage device 21. Further, for example, as shown in FIG. 13, it is preferable that a carriage path 27 including a small gap enabling passage of only the carriage arm 22 and the workpiece 2 is formed to the partition wall 29. When the gap allowing passage of the carriage arm 22 and the workpiece 2 is narrowed in this manner, the contaminated outside air with a different cleanliness can be prevented from flowing from the workpiece supply portion 25 and being mixed, and mixing of a different cleansing liquid mist of the adjacent workpiece processing portion 23 can be avoided. Furthermore, an internal pressure can be gradually increased from the workpiece supply portion 25 toward the workpiece discharge portion 26, or a descending air current can be rectified.

Moreover, the cleansing system 3c has a structure by which the cleansing fluid can flow down from the upper portion of the workpiece processing portion 23. Specifically, as shown in FIG. 14, this structure includes a flowing water jet device 31 which generates ultrasonic waves and superposes them to flowing water, and the ultrasonic flowing water to which the ultrasonic waves are superposed is jetted as a cleansing liquid. To the lower portion of the workpiece processing portion 23 are provided a cleansing fluid exhaust mechanism 33 formed of a hose or the like and a clean air exhaust hole 38 including a fan 38a or a slit 38b. The cleansing fluid is jetted in accordance with presence/absence of the workpiece 2. An angle at which the cleansing fluid is applied or a cleansing position can be freely preferably changed if a jetting direction of the cleansing fluid can be appropriately varied. The cleansing system 3c shown in FIG. 15 is configured to change a direction of the flowing water jet device 31 by utilizing a jet angle change mechanism 32 using a linear motor. Moreover, as shown in FIG. 16, a vertical movement mechanism 36 such as a linear motor which moves up and down workpiece cleansing means 34 such as a cleansing brush provided inside the workpiece processing portion 23 or a rotation mechanism 37 such as a rotary motor may be provided. It is to be noted that the cleansing fluid such as the ultrasonic flowing water is illustrated here, but a drying substitute liquid or drying hot air can be also applied to the cleansing system 3c. The drying substitute liquid is a volatile liquid such as IPA (isopropyl alcohol). FIG. 17 shows the workpiece processing portion 23 to which a cleansing hot air jet mechanism 35 is provided.

Additionally, the cleansing system 3c performs a forward feeding operation from the workpiece processing portion 25 to the workpiece discharge portion 26 at least twice. In this case, it is preferable to provide a function enabling switching a setting of cleansing/drying functions of the workpiece processing portion 23 depending on, e.g., a first operation process or second and subsequent operation processes. As a result, the optimum cleansing can be performed in accordance with a state of the workpiece 2 which differs depending on the first operation process or the second and subsequent operation processes.

Further, the cleansing system 3c vibrates or quivers the workpiece 2 in the workpiece processing portion 23 as shown in FIG. 20 by causing the drive portion 24 to carry out a micromotion operation of swiveling or expansion/contraction, thereby enabling even cleansing with respect to the cleansing liquid jet and the workpiece cleansing means 34. As a result, when the ultrasonic flowing water is not sufficiently supplied to the workpiece 2 for example, the cleansing effect is improved by finely vibrating or quivering the workpiece 2.

The heating/cooling system according to the present invention will now be described. The heating/cooling system in the production system 1 according to this embodiment constitutes a heating/cooling section 4p by using a system (which will be referred to as a “heating/cooling system 3g” hereinafter) formed of the mechanical device 3g used to heat or cool the workpiece 2 as described above.

The heating/cooling system 3g includes, e.g., a heater 71 shown in FIG. 23, a blower 72 which sends air and means for heating the workpiece 2 in the oven 40 like a air cleaning filter 73 as well as means for preheating or cooling before or after the system. The preheating means can be provided at, e.g., a supply opening 65 through which the workpiece 2 is carried into the oven 40. Furthermore, the heating/cooling system 3g comprises a device such as an instrument used to clean a gas which enters the oven 40. The cleaning device can be formed of, e.g., a device which generates a pressure difference when configured to prevent the dust from entering the oven 40 by using a filter which removes the dust or a pressure difference.

The heating/cooling system 3g includes a carriage device 41 which is arranged in the oven 40 capable of accommodating a plurality of workpieces 2 and carries each workpiece 2 to the supply side or the discharge side in the oven 40 and a control portion 42 which controls this carriage device 41. The heating/cooling system 3g operates the carriage device 41 in accordance with each workpiece 2, and individually manages a heating/cooling status of the workpiece 2 in the oven 40. It is to be noted that the carriage device 41 has the same effects or functions as those of the carriage device 8 mentioned above.

Moreover, the heating/cooling system 3g includes a function to generate a route of the carriage device 41 and functions to manage a heating time of each workpiece 2, the number of the latter functions being at least equal to the number of workpieces which can be heated. Here, the function to generate a route of the carriage device 41 is a device which generates a route and a carriage procedure used to move the carriage device 41 and the workpiece 2 from a determined position to another determined position in the oven without interfering structures in the oven or the workpiece 2 accommodated in the oven, and it is constituted of, e.g., means for generating a route for a regular robot. Moreover, the functions to manage a heating time of each workpiece 2 are constituted of a function to set a time predetermined according to the workpiece 2, a function to clock an elapsed time after the workpiece 2 is carried into the oven, and a function to detect that clocking has reached a set value and inform the route generating means of this fact. Additionally, clocking is started upon supply of the workpiece 2, and the carriage device 41 is caused to perform a discharge operation when an elapse of a preset time is detected. Alternatively, the workpiece 2 is moved to another area in the oven with a different temperature or an installation position when an elapse of a preset time is detected, and additionally set clocking is started.

The carriage device 41 is set in such a manner that an operation drive device 43 as a drive mechanism thereof is positioned outside the oven 40 and only an operation end 41a which holds the workpiece 2 enters the oven 40. Here, a method for holding the workpiece by using the operation end 41a includes mounting the workpiece 2 as well as sucking or grasping the same. The operation end 41a and the operation drive device 43 are connected to each other by a shaft portion 41b. Further, a slit 68 is provided to a furnace wall (including a floor of the furnace) so as to constitute a necessary route of the carriage device 41.

The operation drive device 43 includes an X shaft 44 and a Y shaft 45 enabling movement in horizontal two directions orthogonal to each other, and a Z shaft (vertical shaft) 46 enabling movement in the vertical direction. In this case, the dust can be prevented from being generated in the oven by providing as the carriage device 41 a structure that the respective movable shafts, i.e., the X shaft 44, the Y shaft 45 and the Z shaft 46 are connected to each other and a movable portion is not provided at a portion away from the shaft portion 41b. In this embodiment, the X shaft 44 constituted of, e.g., two parallel shafts as shown in FIG. 25, and the Y shaft 45 is provided between them. Movement in the two horizontal directions is carried out by an X shaft drive portion and a Y shaft movement portion constituted of e.g., a motor although not shown in particular.

A first flange 47 is which prevents heated air from flowing out is provided to a swiveling motor fixing portion 46a connected with the Y shaft movement portion as shown in FIG. 27. Furthermore, a second flange 48 which likewise prevents heated air from flowing out is provided to the Y shaft fixing portion 45a which moves together with the X shaft 44 as shown in FIG. 26. In this case, the first flange 47 is disposed to two first flange attachment bodies 49 on the swiveling motor fixing portion 46a, and the second flange 48 is attached to bifurcated second flange attachment bodies 50 of the Y shaft fixing portion 45a. The second flange 48 has a slit 48a through which the first flange attachment bodies 49 can pass when the Z shaft 46 moves in the Y shaft direction.

A shaft portion 41b is provided at the upper portion of the Z shaft 46. Moreover, a pivot 51 of the Z shaft 46 is hollow, and a movable output shaft of the Z shaft 46, i.e., a shaft portion 41b is caused to pierce this hollow portion, thereby balancing the X and Y shafts at the time of horizontal movement and avoiding vibrations during carriage. Additionally, when the shaft portion 41b is hollow, air at an arbitrary position in the oven can be taken out from a hollow opening (e.g., an upper opening end positioned in the oven 40). Further, a sensor wiring 55 and an intake tube 56 are provided inside the hollow shaft portion 41b as shown in FIG. 29. The sensor wiring 55 is connected to a temperature sensor 57 provided at the upper end or the like of the shaft portion 41b and transmits a sensor signal to the detector side. This temperature sensor 57 measures a three-dimensional temperature distribution inside the oven 40. Furthermore, since the Z shaft 46 and the shaft portion 41b are arranged separately in the vertical direction with respect to the Y shaft 45, a moment which acts when driving the X shaft 44 and the Y shaft 45 can be decreased.

As shown in FIG. 29, driving means 52 constituted of, e.g., a motor in order to move the Z shaft 46 or the like along the Y shaft 45 is provided to the swiveling motor fixing portion 46a. For example, in this embodiment, although a hollow direct drive motor which includes a stator coil 53 and a rotor magnet 54 is adopted as shown in the drawing, the driving means 52 is not restricted thereto.

Moreover, the Z shaft 46 includes a slider 58, a linear motor 59, a direct-acting guide rail 60 and a direct-acting guide slider 61. The linear motor 59 drives the slider 58, and moves the shaft portion 41b and the operation end 41a in the vertical direction by moving up and down the slider 58 along the direct-acting guide rail 60.

Incidentally, it is preferable to take a measure to prevent the dust or a gas which may be generated when the above-described carriage device 41 drives from entering the oven 40. For example, in the heating/cooling system 3g shown in FIG. 23, a cover 62 which covers the carriage device 41 is provided, an internal pressure in a closed space constituted of the cover 62 and the furnace wall 63 is decreased, and the dust or the like which may be generated in the carriage device 41 is prevented from entering. In this case, although a fan 64 is provided to the cover 62 in order to decrease a pressure, the pressure decreasing means is not restricted to such a fan.

Although the oven 40 of the heating/cooling system 3g includes one supply opening 65 and one discharge opening 66 for the workpiece 2 as shown in FIGS. 21 and 22, providing a plurality of such openings is also preferable. In such a case, necessary openings are used as the supply opening 65 or the discharge opening 66 in accordance with a process layout before and after the oven 40, and only necessary supply/discharge openings can be used while appropriately closing unused openings with taps or the like, for example. Although not shown, the discharge opening 66 has a discharge sensor which confirms presence/absence of the workpiece 2 sent to a subsequent stage from the discharge opening 66 and informs whether the workpiece 2 in the oven 40 can be discharged.

Further, it is preferable to provide an emergency discharge opening 67 besides the supply opening 65 and the discharge opening 66. The emergency discharge opening 67 enables discharge of the workpiece 2 to the outside from the oven 40 as shown in FIGS. 30 to 33 when the mechanical device 3 or the like in a next process is yet to receive the workpiece 2 at the discharge opening 66 in the normal state. In this case, the heating/cooling system 3g includes a mechanism which discharges the workpiece 2 to the emergency discharge opening 67, e.g., a mechanism constituted of a combination of the carriage device 41 and a opening/closing door 67a of the emergency discharge opening 67 as shown in FIG. 30 or the like. Furthermore, a maintenance door 69 is provided separately from the supply opening 65 or the discharge opening 66 in this embodiment, and the above-described emergency discharge opening 67 is provided to this maintenance door 69. Moreover, a viewing window 70 is provided to the maintenance door 69. It is to be noted that reference numeral 74 denotes a high-temperature area in the oven 40; 75, a low-temperature area in the same; and 76, a temperature partition plate in FIG. 30.

Incidentally, it is preferable to provide a function to modify an abnormal state at the time of abnormality that the workpiece cannot be discharged from the oven 40 even if the emergency discharge opening 67 is provided. This function may be realized by a software method to control the control portion 42, e.g., stopping a workpiece supply fetch sequence in the control portion 42 at the time of abnormality.

Additionally, it is preferable for the heating/cooling system 3g to have a function to comprehend a position and an elapsed time of the workpiece 2 mounted in the oven 40 and display its contents. In such a case, a heating/cooling status, a management status and the like of the workpiece 2 can be further accurately comprehended. A workpiece position can be grasped based on, e.g., a number or the like assigned to a mount position. Such a function is effective when performing a system management combined with software such as a database used to manage data for each workpiece. It is to be noted that the same management method can be adopted when the oven 40 is partitioned by the temperature partition plate 76 or the like and an intended temperature distribution is provided in the oven 40. However, in this case, movement to another mount position is carried out in place of the discharge operation, and the management is conducted.

A description will now be given as to an outline of the system control when a heating/cooling time of the workpiece 2 is managed with reference to FIG. 35. First, it is detected whether there is a workpiece 2 whose preset time has elapsed and which has run out of time among workpieces 2 subjected to thermal management at respective management positions in the oven 40 (step 1). If there is a workpiece 2 which has run out of time, the discharge sensor which detects whether there is a workpiece 2 at the discharge opening 66 detects if the current state is an “absent” state and judges whether the workpiece 2 can be discharged (step 2). If the workpiece 2 can be discharged, a number of a corresponding mount position is used, and a command to generate a route is issued to the function which generates a route for the carriage device (step 3). On the other hand, if the workpiece 2 cannot be discharged, it is discharged to the emergency discharge opening 67, or error processing is performed (step 4). At each of the steps 3 and 4, corresponding data is deleted from the workpiece management database (step 5).

On the contrary, if there is no workpiece 2 which has run out of time, it is detected whether a new workpiece 2 is inputted (step 6). When it is not inputted (N in the drawing), a closed loop is followed and the processing returns to the step 1. On the other hand, when it is inputted (Y in the drawing), a workpiece number management is inquired for an unoccupied mount position number. If the number is obtained, it is written into the workpiece management database. If the unoccupied mount position number is not obtained (N in the drawing), the loop is followed and the processing returns to the step 1 (step 7). If there is the unoccupied mount position number and it is written into the workpiece management database (Y in the drawing), a load coordinate position is obtained based on the unoccupied mount position number (step 8), and a run-out time and the mount position number are written into the workpiece management database (step 9). Then, a command to mount the workpiece 2 at the mount position number is transmitted to a robot route generation portion (step 10). After executing this command, the closed loop is followed and the processing returns to the step 1. Then, the time management control based on the system control is repeatedly carried out.

FIGS. 36 to 42 illustrate another embodiment of the heating/cooling system 3g according to the present invention.

A stack (which will be referred to as a “mount base” hereinafter) on which the workpiece 2 to be heated is placed is provided in the oven 40 of the heating/cooling system 3g. In the above-described embodiment, the mount bases are provided in a plurality of rows and columns in the oven 40 (see FIGS. 21 to 23), and the operation end 41a of the carriage device 41 can be swiveled in such a manner that the workpiece 2 can be put in/taken out with respect to any mount bases on the right and left sides of the slit 68. On the contrary, when the mount bases 77 are arranged in, e.g., one column, the workpiece 2 can be put in/taken out with respect to any mount bases 77 by combining horizontal and vertical movements without swiveling the operation end 41a. Therefore, the structure of the carriage device 41 becomes simple because a device to swivel the operation end 41a is not necessary, and the operation to access the workpiece 2 can be facilitated since the control is carried out in only three shaft directions of X, Y and Z.

An example of a mechanism to drive the Z shaft 46 will now be described. In this embodiment, as shown in FIG. 36, a Z shaft drive nut 80 is fixed to the shaft portion 41b of the carriage device 41, and the carriage device 41 is moved up and down by moving up and down the Z shaft drive nut 80 along a guide 82. The Z shaft drive nut 80 is engaged with a vertically provided Z shaft drive screw 81. The Z shaft drive screw 81 is driven to rotate by a Z shaft drive motor 85 through a belt 83 and a pulley 84. It is to be noted that reference numeral 94 denotes an X shaft auxiliary guide; 95, an X shaft drive actuator; 96, a Y shaft drive actuator; 97, a support pin of the first flange 47; and 98, a support pin of the second flange 48 in FIG. 36.

Further, it is preferable that the opening portion on the lower surface of the oven 40 is as small as possible and a cover or a flange is attached thereto in order to keep the heated air in the oven 40. As shown in FIG. 37, the opening portion of the oven 40 in this embodiment is divided into an opening portion 86 used to move the carriage device 41 in the front-and-back direction and the right-and-left direction within a predetermined range and an opening portion (supply/discharge opening) 87 used to carry the workpiece 2 into the oven 40 and supply and to carry the same out of the oven 40 and discharge. A total area of these openings is set as small as possible. The opening portion 86 is covered with the second flange 48 which moves in the axial direction of the X shaft 44 together with the carriage device 41. The second flange 48 is set in such a manner that a gap between itself and the lower surface of the main body of the oven 40 becomes very small, and has a dimension to cover both the opening portion 86 and the opening portion 87. Furthermore, the first flange 47 which covers the slit 48a of the second flange 48 is provided on the lower side of the second flange 48. The first flange 47 is set with a required minimum gap on the lower surface of the second flange 48. The first flange 47 and the second flange 48 close the opening portion 86 to suppress the heated air from flowing out and prevent heat in the oven 40 from diffusing. Moreover, in this embodiment, a workpiece carriage pallet 88 used to supply the workpiece 2 into the oven 40 or discharge the same from the oven 40 is inserted into the opening portion 87, thereby suppressing outflow of the heated air from the opening portion 87. The workpiece carriage pallet 88 is a base on which the workpiece 2 is mounted at a predetermined position thereon, and it is detachably provided to the work carriage cart 89. The self-propelled workpiece carriage cart 89 is a cart which travels along a carriage rail 90 having, e.g., a channel-shaped cross section. It travels and stops at a predetermined position upon receiving a command from, e.g., a non-illustrated infrared sensor. Additionally, a lifter 91 which pushes up the workpiece carriage pallet 88 by using, e.g., push-up pins 92 at four corners is provided below the opening portion 87. This lifer 91 pushes up only the workpiece carriage pallet 88 on the workpiece carriage cart 89 stopped on the carriage rail 90, and inserts it into the opening portion 87. With the above-described structure, in the heating/cooling system 3g according to this embodiment, it is possible to suppress outflow of the heated air in the oven 40 during supply/discharge of the workpiece 2 and during a time other than the supply/discharge (see FIGS. 38 to 40). That is, in a standby mode to wait for the workpiece 2 to be supplied into the oven 40, both the opening portions 86 and 87 can be covered with the second flange 48 (see FIG. 38). Further, when supplying the workpiece 2, the second flange 48 is moved in the axial direction of the X shaft 44 together with the carriage device 41 in order to open the opening portion 87 as shown in FIG. 39, and the workpiece carriage pallet 88 is pushed up and inserted into the opening portion 87. While performing an operation of, e.g., carrying the workpiece 2 on the workpiece carriage pallet 88 to a predetermined mount base 77 by using the carriage device 41 or returning the workpiece 2 on the mount base 77 onto the workpiece carriage pallet 88, the workpiece carriage pallet 88 suppress outflow of the heated air (see FIG. 40). It is to be noted that a notch 48b which prevents the interfere with the push-up pins is provided to the second flange 48 in this embodiment (see FIGS. 37 and 40).

It is to be noted that the workpiece carriage pallet 88 is inserted into the opening portion which is slightly larger than the workpiece carriage pallet 88 but it is just an example for suppressing outflow of the air from the opening portion 87. For example, the workpiece carriage pallet 88 larger than the opening portion 87 may be put on and cover the opening portion 87 (see FIG. 41), or an edge portion of the workpiece carriage pallet 88 may be pressed against and cover a step portion provided at a rim of the opening portion 87 (see FIG. 42).

A description will now be given as to an embodiment which uses the oven 40 as a cooling furnace and enables clean cooling by flowing workpieces 2 one by one in the first-in-first-out order (see FIG. 43). The oven 40 as a cooling furnace is a device provided in a post-process of the heating oven in order to cool the heated workpiece 2, for example. As shown in the drawing, a cleaning device 5 which supplies clean air and exhaust means 14 for exhausting air are provided. Furthermore, a support plate 78 used to support the mount base 77 is constituted of, e.g., a bent plate with a plurality of holes formed thereto such as a punching metal so as to transmit the clean air. In this embodiment, however, a flow path 93 is formed without forming holes on the upper surface portion of the bent plate so that the clean air passes through this flow path 93 to reach the side in the oven 40. The clean air which has reached the side is blown out into the operation area 9 through the holes of the support plate 78, and cools the high-temperature workpiece 2 placed on the mount base 7 to a temperature substantially equal to that of outside air. Furthermore, the air with a high temperature is exhausted to the outside by the exhaust means 14 through the mechanism area 10. Such a flow of air cools the high-temperature workpiece 2 placed in a clean closed space to a temperature substantially equal to that of outside air in a short time while maintaining the cleanliness.

Here, when the mount bases 77 are provided in a plurality of columns, since the clean air blown out from the holes of the support plate 78 passes through the vicinity of a plurality of the workpieces 2 sequentially mounted on the mount bases 77 from the support plate 78 side, the clean air is gradually contaminated every time it passes through the vicinity of the workpieces 2, and the cleanliness of all the workpieces 2 mounted on the mount bases 77 is hard to be assured. However, since the number of columns of the mount bases 77 is one in this embodiment, such a problem does not occur. Further, since a temperature of the clean air is increased every time it passes through the vicinity of the workpieces 2, it is preferable that the number of columns of the mount bases 77 is one in order to evenly cool the workpieces 2 set on the mount bases 77.

Furthermore, when the oven 40 is used as a heating oven in place of a cooling furnace, it is preferable that the number of columns of the mount bases 77 is one in order to assure the cleanliness of the workpieces 2 or perform homogeneous heating.

The flow path 93 has a sufficient width that a human hand can be inserted therein in order to facilitate cleaning or maintenance of the support plate 78 or the like.

It is to be noted that the above is the preferred embodiments according to the present invention, but the present invention is not restricted thereto, and various kinds of modifications can be carried out without departing from the scope of the invention. For example, although the description has been given as to the heating/cooling system that the present invention is applied to a temperature furnace, the invention can be also applied to a furnace other than such a temperature furnace, e.g., an equivalent furnace mode such as an ultraviolet furnace.

Moreover, although the carriage device 41 is provided on the bottom of the oven 40 and the shaft portion 41b pierces the furnace wall (for detail, this is a floor of the furnace) in this embodiment, the carriage device 41 may be provided on the side of the oven 40. In this case, although not illustrated in particular, the shaft portion 41b of the carriage device 41 is configured to face the horizontal direction and pierce the side furnace wall 63. Additionally, in this case, the operation drive device 43 can be arranged on the side portion of the oven 40, and it does not have to be arranged below the oven 40. Therefore, the hot air in the oven 40 can readily flow in the vertical direction, e.g., from the upper side to the lower side.

1. A heating/cooling system comprising: a carriage device being arranged in an oven capable of accommodating a plurality of workpieces therein, and carrying each workpiece from a supply opening to a discharge opening in the oven; and a control portion for operating the carriage device in accordance with each workpiece and controlling the carriage device so as to individually manage a heating/cooling status of the workpiece in the oven.

2. A heating/cooling system comprising: a robot type carriage device for carrying a workpiece; and a control portion having a function to generate a route of the carriage device as well as functions to manage a heating/cooling time of each workpiece, the number of the functions is at least equal to the number of the workpieces which can be heated/cooled, and controlling the carriage device so as to cause the carriage device to perform a discharge operation when an elapse of a preset time is detected after starting clocking from supply of the workpiece.

3. A heating/cooling system comprising: a robot type carriage device for carrying a workpiece; and a control portion having a function to generate a route of the carriage device as well as functions to manage a heating/cooling time of each workpiece, the number of the functions is at least equal to the number of the workpieces which can be heated/cooled, controlling the carriage device to move to another area in a furnace with a different temperature or a mount position when an elapse of a preset time is detected after starting clocking from supply of the workpiece, and starting additionally set clocking.

4. The heating/cooling system according to any one of claims 1 to 3, wherein the carriage device is set in such a manner that an operation drive device as a drive mechanism thereof is positioned outside the oven and only an operation end which holds the workpiece enters the oven.

5. The heating/cooling system according to claim 4, wherein the operation end is connected with the operation drive device by a shaft portion and a slit is provided on a furnace wall only in a necessary route of the carriage device.

6. The heating/cooling system according to claim 5, further comprising a flange which prevents heated air from flowing out from the slit.

7. The heating/cooling system according to claim 6, wherein the flange is constituted of a first flange provided at a swiveling motor fixing portion connected to a Y shaft movement portion and a second flange provided at a Y shaft fixing portion which moves together with an X shaft.

8. The heating/cooling system according to claim 4, wherein the carriage device has a structure that a movable portion is not provided on the operation end side away from the shaft portion which connects the operation end with the operation drive device.

9. The heating/cooling system according to claim 4, wherein a pivot which swivels the operation end of the carriage device is hollow and has a structure to cause the shaft portion to pierce the pivot.

10. The heating/cooling system according to any one of claims 1 to 3, wherein the heating/cooling system has a structure which has a cover to cover the carriage device, reduces pressure in a closed space surrounding the movable portion constituted of the cover and a furnace wall, and prevents dust generated by the carriage device and a gas from entering the oven.

11. The heating/cooling system according to any one of claims 1 to 3, wherein the heating/cooling system has a structure which has a plurality of the supply openings or the discharge openings for the workpieces, uses necessary openings as the supply/discharge openings in accordance with a process layout before and after the oven, and can close an unused opening with a tap.

12. The heating/cooling system according to claim 11, wherein the heating/cooling system has an emergency discharge opening besides the supply opening or the discharge opening, and includes a function to discharge a workpiece at the discharge opening to the emergency discharge opening when a mechanical device which performs a next process is yet to receive the workpiece in a normal state.

13. The heating/cooling system according to claim 11, wherein the heating/cooling system has a maintenance door other than the supply opening or the discharge opening.

14. The heating/cooling system according to any one of claims 1 to 3, wherein the heating/cooling system has a function capable of displaying a position and an elapsed time of the workpiece mounted in the oven.

15. The heating/cooling system according to any one of claims 1 to 3, wherein the heating/cooling system has a function to stop a workpiece supply operation in case of abnormality that the workpiece cannot be discharged from the oven.

16. The heating/cooling system according to any one of claims 1 to 3, wherein the heating/cooling system has a temperature sensor in the carriage device and thereby includes a function capable of measuring a three-dimensional temperature distribution in the oven.

17. The heating/cooling system according to claim 5, wherein the shaft portion is hollow.

18. The heating/cooling system according to claim 5, wherein the heating/cooling system has a structure that the carriage device is arranged on the side of the oven and the shaft portion pierces the furnace wall in the horizontal direction.

19. The heating/cooling system according to any one of claims 1 to 3, further comprising a device for cleaning a gas which enters the oven.

20. The heating/cooling system according to any one of claims 1 to 3, wherein the heating/cooling system is used in an ultraviolet furnace.

21. The heating/cooling system according to any one of claims 1 to 3, wherein outflow of heated air in the oven is suppressed by inserting a workpiece carriage pallet having the workpiece mounted thereon in order to supply the workpiece into the oven or discharge it from the oven, into an opening portion through which the workpiece is supplied or discharged.

22. A production system comprising: a plurality of mechanical devices each having a workpiece operation section in which an operation is performed with respect to a workpiece; a device which maintains the workpiece operation section in a clean atmosphere; a carriage device which moves the workpiece in the workpiece operation section; an operation drive device which drives the carriage device and is provided outside the workpiece operation section; and a carriage path which connects the workpiece operation sections of the respective mechanical devices with each other and carries the workpiece from one mechanical device to another mechanical device, wherein at least one of the mechanical devices is the heating/cooling system according to any one of claims 1 to 3.
